(19) United States
(12) Patent Application Publication
(10) Pub. No.: US 2026/0070289 A1
(43) Pub. Date: Mar. 12, 2026

(54) SYSTEMS, DEVICES AND METHODS FOR THE MANUFACTURE OF PLASTIC AND FIBER-REINFORCED PLASTIC STRUCTURES

(71) Applicant: Perseus Materials, Inc., Knoxville, TN (US)

(72) Inventors: Daniel C. Lee, Knoxville, TN (US); John Feist, Alameda, CA (US); Zachary Waring, Knoxville, TN (US); Michael Hu, Knoxville, TN (US)

(21) Appl. No.: 19/385,100

(22) Filed: Nov. 10, 2025

Related U.S. Application Data
(63) Continuation of application No. PCT/US2024/028844, filed on May 10, 2024.
(60) Provisional application No. 63/501,298, filed on May 10, 2023.

(51) Int. Cl. B29C 70/52

(52) U.S. Cl. CPC B29C 70/526; B29C 70/521; B29C 70/528

(57) ABSTRACT

Systems, devices, and methods for manufacture plastic and fiber-reinforced plastic structures with complex geometries are disclosed herein. In some embodiments, a device can include a dynamic tooling member positioned to receive a material in an opening of the dynamic tooling member, an actuator coupled to the dynamic tooling member, and a stimulus member positioned to provide a stimulus to a portion of the material passing through or beyond the opening. The actuator can dynamically change a shape of the dynamic tooling member, and the stimulus can chemically alter the portion of the material passing through the opening such that the portion of the material retains the imparted shape.

### CROSS-REFERENCE TO RELATED APPLICATIONS

The present application is a continuation of International Patent Application No. PCT/US24/28844, filed on May 10, 2024, which claims the benefit of U.S. Provisional Patent Application No. 63/501,298, filed May 10, 2023, each of which are incorporated herein by reference in its entirety.

### GOVERNMENT INTEREST

This invention was made with government support under DE-AR0001795 awarded by the U.S. Department of Energy, and 2304621 awarded by the National Science Foundation. The government has certain rights in the invention.

### TECHNICAL FIELD

This present technology relates to systems, devices and methods for the manufacture of plastic and fiber-reinforced plastic structures. Some embodiments relate to systems, devices and methods for manufacturing plastic structures with complex shapes by curing a resin.

### BACKGROUND

Manufacturing structures with complex geometries and demanding mechanical properties, such as wind turbine blades and aircraft wings, can be time-consuming and expensive. Long lead times for molds (e.g., 12+ months) and limited build capacity have led to demand significantly outpacing supply. For example, manufacturing fiber-reinforced plastic structures by covering a mold with reinforcing fibers and performing vacuum-assisted resin transfer molding requires significant manual labor, is too time consuming for high-volume manufacturing, and results in high product defect rates. In another example, pultrusion enables automated and relatively rapid production of fiber-reinforced plastic structures with very low defect rates, but only allows structures with a constant cross-section (e.g., pipes, I-beams, girders) to be manufactured. In yet another example, melted thermoplastic can be rapidly solidified in a short, cooled die to have varying shape, but thermoplastics are undesirable for many applications, such as those that require high temperature tolerance or creep resistance. As such, there is a need for systems that can rapidly manufacture structures of various and complex geometries using materials with satisfactory mechanical properties.

### BRIEF DESCRIPTION OF THE DRAWINGS

Features, aspects, and advantages of the presently disclosed technology may be better understood with regard to the following drawings.

FIG. 1 is a schematic view of a material shaping system, configured in accordance with embodiments of the present technology.

FIG. 2 is a schematic view of another material shaping system, configured in accordance with embodiments of the present technology.

FIG. 3 is a perspective view of yet another material shaping system, configured in accordance with embodiments of the present technology.

FIG. 4 is a perspective view of a feed assembly included in the material shaping system of FIG. 3.

FIG. 5 is a perspective view of a resin bath included in the material shaping system of FIG. 3.

FIG. 6 is a perspective, partially exploded view of a material moving assembly included in the material shaping system of FIG. 3.

FIG. 7A is a perspective view of a material shaping device included in the material shaping system of FIG. 3.

FIG. 7B is an enlarged view of the material shaping device of FIG. 7A.

FIG. 7C is a front view of the material shaping device of FIG. 7A.

FIG. 8 is a front view of another material shaping device, configured in accordance with embodiments of the present technology.

FIG. 9 is a perspective view of another material shaping device, configured in accordance with embodiments of the present technology.

FIGS. 10-12B are perspective views of various examples of dynamic tooling members, configured in accordance with embodiments of the present technology.

FIGS. 13-20 are front views of various examples of dynamic tooling members, configured in accordance with embodiments of the present technology.

FIGS. 21 and 22 are front isometric views of various examples of dynamic tooling members, configured in accordance with embodiments of the present technology.

FIG. 23A is a perspective view of another material shaping system, configured in accordance with embodiments of the present technology.

FIGS. 23B and 23C are enlarged perspective views of different portions of the material shaping system of FIG. 23A.

FIG. 24 is a flowchart illustrating a method of shaping a material, configured in accordance with embodiments of the present technology.

A person skilled in the relevant art will understand that the features shown in the drawings are for purposes of illustrations, and variations, including different and/or additional features and arrangements thereof, are possible.

### DETAILED DESCRIPTION

### I. Overview

Embodiments of the present technology relate to systems and methods for manufacturing plastic and fiber-reinforced plastic structures with varying cross-sections. Current methods of manufacturing plastic structures include: (1) melting solid plastic to molten plastic, shaping the molten plastic to a desired shape, and then cooling the shaped molten plastic back to solid plastic and (2) adding reactive liquids to a static mold and causing the liquid to solidify by means of polymerization. However, these methods are limited in the type of material that can be used and/or by the excessive time required to shape the material into the desired structure due to the slow rate of solidification. Also, prolonged heating required by these methods can consume considerable amounts of energy, contributing to greenhouse gas emissions.

Embodiments of the present technology address at least some of the above-described issues. For example, embodiments of the present technology include (i) a dynamic tooling member positioned to receive a material in a gap or opening of the dynamic tooling member, (ii) at least one actuator coupled to the dynamic tooling member, and (iii) a stimulus member positioned to provide a stimulus to a portion of the material passing through or beyond the gap or opening of the dynamic tooling member. The actuator can be configured to dynamically change at least one of a shape, position, or orientation of the dynamic tooling member and/or a gap or opening of the dynamic tooling member. The shape, position, and orientation of the gap or opening of the dynamic tooling member can be imparted to the portion of the material passing through the gap or opening, and the stimulus can chemically alter the portion of the material passing through or beyond the gap or opening such that the portion of the material retains the imparted shape, position, and orientation.

Additionally or alternatively, embodiments of the present technology can also include a material shaping system including a material shaping device and a material moving assembly configured to move the material through and away from the material shaping device. The system can also include a feed assembly and/or a resin bath positioned upstream of the material shaping device. The feed assembly can feed raw material to the resin bath or the dynamic tooling member. The resin bath can coat the raw material in a resin that can be rapidly cured upon exposure to the stimulus.

Embodiments of the present technology also include a method of shaping a material. The method can include receiving a material in a gap or opening of a dynamic tooling member, changing at least one of a shape, position, or orientation of the gap or opening of the dynamic tooling member such that the shape, position, and orientation of the gap or opening is imparted to a portion of the material passing through the gap or opening, and applying a stimulus to at least one of (i) the portion of the material passing through the gap or opening or (ii) a portion of the material passing beyond the gap or opening. The stimulus can chemically alter the portion of the material passing through or beyond the gap or opening such that the portion of the material retains the imparted shape, position, and orientation.

Embodiments of the present technology provide several advantages and improvements relative to related conventional technology. For example, unlike related conventional technologies, embodiments of the present technology do not require molds and other static tooling, which can be extremely expensive and time-consuming to obtain (e.g., especially if the structure to be produced requires different tool sets for different geometry parts), and which consequently slow production and add friction to design iterations. Embodiments of the present technology can produce structures with complex geometries and with fewer size constraints compared to, for example, additive manufacturing (e.g., 3D printing) or automated batch processes. The produced structures (e.g., composites) are also expected to have lower defect rates and improved surface finishes compared to conventional technology. Additionally, embodiments of the present technology can include a high level of automation, significantly reducing the manual labor needed and the high defect rates and operational expenditures associated with manual labor. Furthermore, embodiments of the present technology can mitigate climate change by accelerating the production of structures such as wind turbine blades, and by producing structures in a generally more environmentally friendly manner, such as by utilizing resins that cure with minimal energy input and/or using recyclable materials.

As described elsewhere herein, embodiments of the present technology are directed to a continuous molding process for the fabrication of thermosets, plastics (e.g., thermoplastics), or fiber-reinforced polymer composite structures with varying cross-sections and/or surface contours. The fabrication can be completed in a relatively short period of time while meeting the structural requirements of, for example, wind turbine blades and aircraft wings. The opening of the dynamic tooling member can be shaped via actuators, and can change shape and size as a material (e.g., a resin or resin-coated fillers or resin-coated fibers) is passed through the opening and undergoes frontal polymerization or is cured relatively rapidly (e.g., less than one second, five seconds, or ten seconds). The material can be cured via a stimulus member (e.g., a heater, light source, electromagnetic stimulator, etc.) coupled to the dynamic tooling member. As the material undergoes a change in chemical structure and solidifies due to polymerization/curing effected by the stimulus from the stimulus member, the shape of the opening of the dynamic tooling member defines a cross-section that is imparted to the material. As the material continues to pass through the opening, the shape of the opening of the dynamic tooling member can be dynamically changed such that the material can have varying cross-sections along its length.

In the Figures, identical or similar reference numbers identify generally similar, and/or identical, elements. Many of the details, dimensions, and other features shown in the Figures are merely illustrative of particular embodiments of the disclosed technology. Accordingly, other embodiments can have other details, dimensions, and features without departing from the spirit or scope of the disclosure. In addition, those of ordinary skill in the art will appreciate that further embodiments of the various disclosed technologies can be practiced without several of the details described below.

### II. Systems, Device and Methods for Shaping Materials

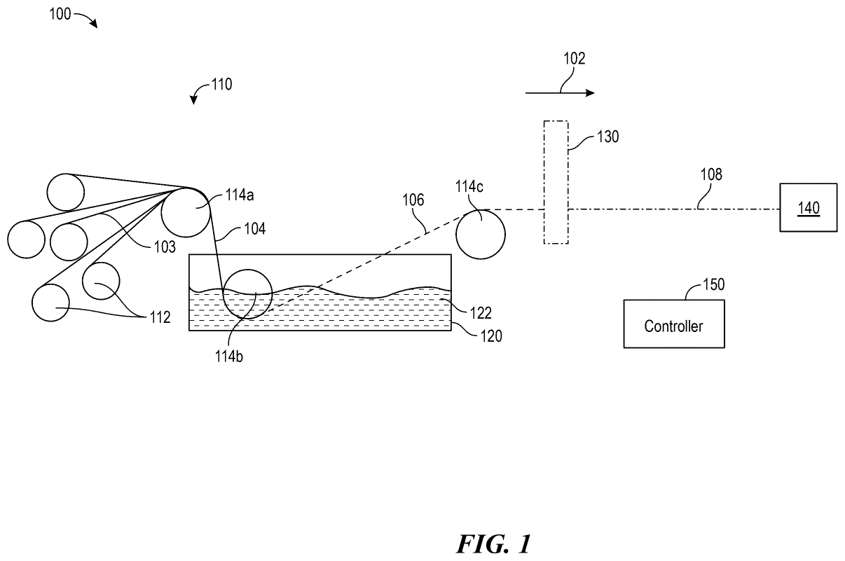

FIG. 1 is a schematic view of a material shaping system 100, configured in accordance with embodiments of the present technology. The material shaping system 100 includes a material shaping device 130 that can shape a material to a desired structure, as will be described in greater detail below. The material shaping system 100 can also include a feed assembly 110 and a resin bath 120 upstream of the material shaping device 130, a material moving assembly 140 downstream of the material shaping device 130, and a controller 150.

In the illustrated embodiment, the feed assembly 110 comprises a creel system including one or more spools 112 holding raw material 103 (e.g., continuous glass or carbon fiber rovings, unidirectional continuous fiber mats, unidirectional glass fiber fabric, woven bi- or multi-directional continuous fiber fabrics, chopped woven or chopped non-woven fiber fabric or mats, veil mats) and one or more material guides 114a/b/c (collectively referred to as “the material guides 114”; e.g., rollers, guide plates). One or more resin baths 120 (“resin bath 120”) can be positioned between the one or more spools 112 and the material shaping device 130. The resin bath 120 can be filled with a resin 122. In some embodiments, one or more of the material guides 114 is positioned adjacent or at least partially in the resin 122. The material moving assembly 140 (e.g., computer numerical control (CNC) grippers, rollers, conveyors) can be positioned downstream of the material shaping device 130 to move (e.g., pull) solidified material from the material shaping device 130. Additionally or alternatively, the material moving assembly 140 can be positioned upstream of the material shaping device 130 to push the material.

In operation, the spools 112 of the feed assembly 110 can feed, for example, fiber strands of the raw material 103 to a first material guide 114a in order to combine and/or group the fiber strands of the raw material 103 to form dry fibers 104. A second material guide 114b can then expose the fiber strands of the raw material 103 or the dry fibers 104 into the resin 122 contained in the resin bath 120 in order to prepare wetted fibers 106. A third material guide 114c then feeds the wetted fibers 106 to the material shaping device 130 in a movement direction 102. The material shaping device 130 then shapes and solidifies the wetted fibers 106 to form a desired structure 108. Examples and operation of the material shaping device 130 is described in further detail herein. The material moving assembly 140 can then move (e.g., pull) the desired structure 108 away from the material shaping device 130 in the movement direction 102.

The controller 150 (e.g., a CNC controller) can be operably coupled to components of the feed assembly 110 (e.g., the material guides 114), the material shaping device 130, and/or the material moving assembly 140. For example, the controller 150 can control and/or regulate the material guides 114 and the material moving assembly 140 together to synchronize their operation and/or to control a travel speed of the material passing through the material shaping device 130 in the movement direction 102. Such control can be based on, e.g., a stimulus provided by a stimulus member (as described below), the resin 122, the fiber strands of the raw material 103, and/or an expected curing time of the resin 122 to form the desired structure 108. The controller 150 can also control the material guides 114, the material shaping device 130, and/or the material moving assembly 140 together to control a predetermined tension or compression level of the material as the material passes through the material shaping device 130 in the movement direction 102.

In some embodiments, the resin 122 can be neat, imbued with fibers, enveloping reinforcing fibers, or imbued with other fillers such as glass bubbles, salts, fire-retardants, UV-protecting agents, pigments, viscosity modifiers, etc. In some embodiments, the resin 122 is a resin that undergoes frontal polymerization (e.g., converting a monomer to a polymer by propagation of a localized reaction wave) or a fast-curing resin, such as the resin described in International Patent Application Publication WO 2022/212752, titled “DEGRADABLE COPOLYMERS OF ENOL ETHERS WITH OLEFINIC MONOMERS,” the disclosure of which is incorporated herein by reference in its entirety. In some embodiments, the resin 122 is one of epoxy-anhydride resins, epoxy resins, vinyl ether resins, cyclic ether resins, polyester resins, dicyclopentadiene resins, cycloalkenyl resins, acrylic resins, methacrylic resins, methacrylamide resins, vinyl ester resins, urethane resins, or any combinations thereof. In some embodiments, the resin 122 is a snap-curing resin. The curing rate of the resin 122 affects the range of possible travel speeds in the movement direction 102 and can allow the material shaping device 130 to rapidly shape the material.

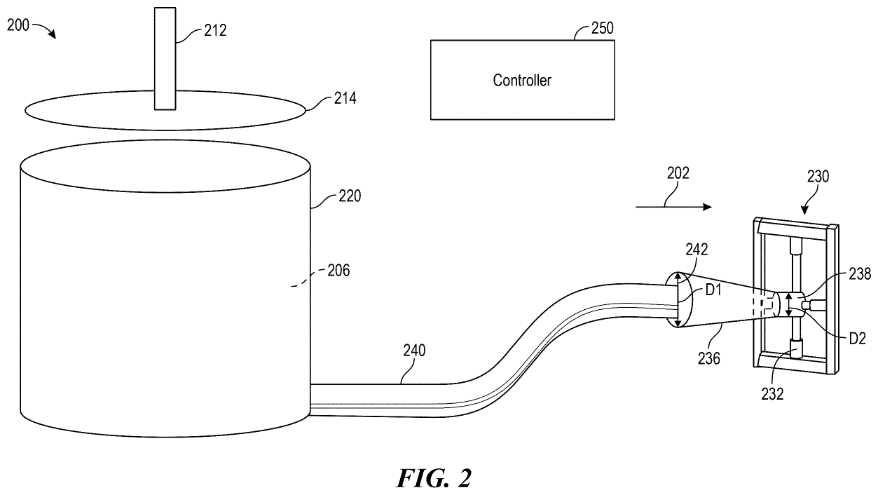

FIG. 2 is a schematic view of another material shaping system 200, configured in accordance with embodiments of the present technology. The material shaping system 200 can include a plunger 214, a reservoir 220, tubular member 240 coupled to the reservoir 220, a material shaping device 230 coupled to the tubular member 240, and a controller 250. It is appreciated that the material shaping system 200 may share some similarities with the material shaping system 100, and that similarly numbered components may be similar in structure and function. For example, the material shaping device 230 can include any of the features and functionality described with reference to the material shaping device 130.

The reservoir can be filled with a material 206 to be shaped. For example, the material 206 can include chopped glass fibers mixed with resin (e.g., the resin 122). The length of each chopped glass fiber can be at least 0.1 cm, 0.2 cm, 0.3 cm, 0.4 cm, or 0.5 cm in length. The tubular member 240 can be coupled between the reservoir 220 and the material shaping device 230. In some embodiments, the tubular member 240 is coupled to the material shaping device 230 via a fitting 242 attached to the tubular member 240. In some embodiments, the tubular member 240 comprises a flexible tube or hose.

The material shaping device 230 can include one or more actuators 232, a dynamic tooling member 236, and a stimulus member 238. In the illustrated embodiment, the dynamic tooling member 236 is shaped to be a flexible nozzle (e.g., made of a hollow silicone elastomer) that narrows in diameter from a proximal end portion having a first cross-sectional dimension D1 to a distal end portion having a second cross-sectional dimension D2 along a travel direction 202 of the material 206. The first cross-sectional dimension D1 can be at least 1 in, 2 in, 3 in, 4 in, 5 in, 1-5 in, or other values. The second cross-sectional dimension D2 can be at least 0.1 in, 0.5 in, 1 in, 2 in, 3 in, 0.1-3 in, or other values.

The stimulus member 238 can be positioned adjacent, coupled to, or positioned downstream (e.g., by at least 1 mm, 5 mm, 1 cm, 10 cm, etc. from the downstream end) of the dynamic tooling member 236. The stimulus member 238 can trigger and/or accelerate a physical and/or chemical change in at least a portion of the material 206. For example, the stimulus member 238 can include a heater that heats the surface or at least a portion of the dynamic tooling member 236 to a temperature of at least 30° C., 75° C., 100° C., 150° C., 200° C., 250° C., 300° C., 500° C., 30-500° C., 30-250° C., or other values such that the heat can be transferred to and absorbed by the material 206. In some embodiments, the material 206 includes a resin and the heat can initiate frontal polymerization of the resin. In other examples, the stimulus member 238 is configured to provide other forms of stimuli, such as light, sound waves, etc. The stimulus member 238 can be configured to solidify and/or change the chemical structure of (e.g., frontal polymerization) the surface layer of the material 206 (e.g., adjacent to the dynamic tooling member 236) in no more than 10 seconds, 5 seconds, 3 seconds, 1 second, or other values. For example, the stimulus member can apply heat or other stimulus to form a solidified skin on the material in no more than 10 seconds, 5 seconds, 3 seconds, 1 second, or other values. In some embodiments, the stimulus can propagate through (e.g., inwardly) the thickness of the material 260 as the material 206 continues to be pushed beyond the stimulus member 238 downstream (e.g., polymerization can continue through the resin's thickness). For example, the stimulus can be applied to solidify the material at a rate of at least 0.05 millimeters/second (mm/s), 0.1 mm/s, 0.2 mm/s, 0.3 mm/s, 0.5 mm/s, 0.05-0.5 mm/s, or other rates through the thickness of the material.

In operation of the material shaping system 200, the plunger 214 can be actuated by an actuator 212 (e.g., a screw actuator) to pressurize the reservoir 220 to force the material 206 to flow downstream into the tubular member 240. Additionally or alternatively, the reservoir 220 can be filled with pressurized gas and/or can be decreased in volume (e.g., squeezed) to force the material 206 to flow downstream into the tubular member 240. The actuators 232 can, in response to inputs from the controller 250, continuously and dynamically shape the distal end portion of the dynamic tooling member 236, and thereby shape the portion of the material 206 passing therethrough. For example, the dynamic tooling member 236 can be transformed from a circular cross-section to an elliptical cross-section.

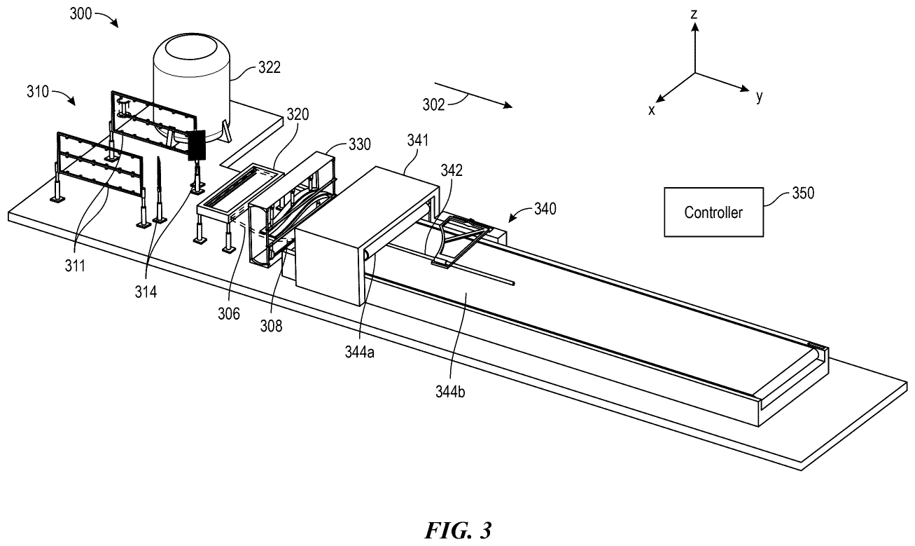

FIG. 3 is a perspective view of yet another material shaping system 300, configured in accordance with embodiments of the present technology. The material shaping system 300 can include a feed assembly 310, a resin bath 320 distal to (e.g., downstream of) the feed assembly 310, a material shaping device 330 distal to the resin bath 320, a material moving assembly 340 distal to the material shaping device 330, and a controller 350 (shown schematically) operably coupled to the feed assembly 310, the resin bath 320, the material shaping device 330, and/or the material moving assembly 340. The feed assembly 310, the resin bath 320, the material shaping device 330, and the material moving assembly 340 can be arranged in an assembly line, as shown, such that the material moves in a travel direction 302. It is appreciated that the material shaping system 300 may share some similarities with the material shaping system 100, and that similarly numbered components may be similar in structure and/or function.

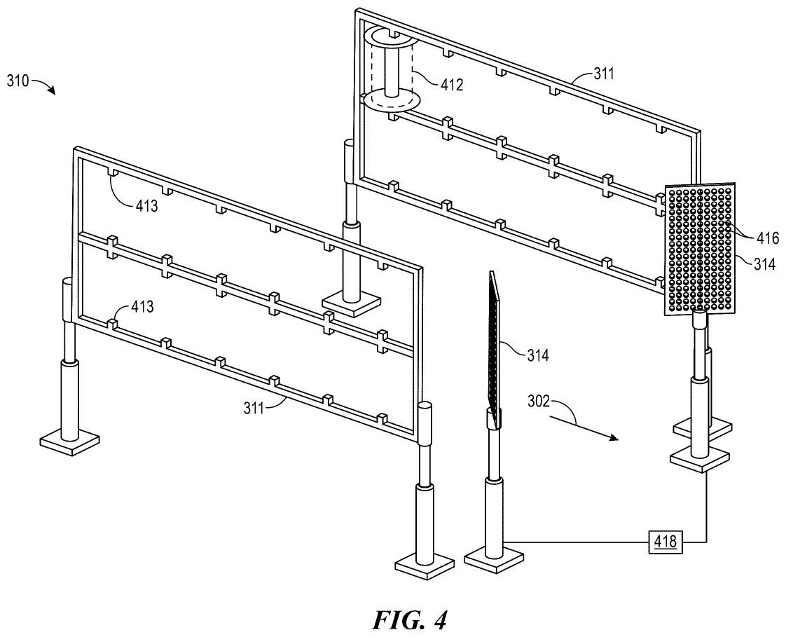

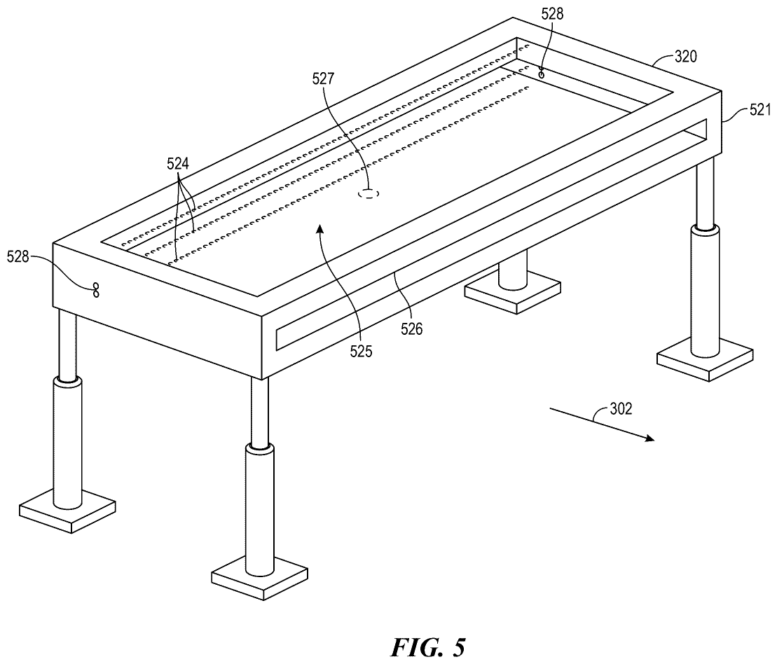

The feed assembly 310 can include one or more spool frames 311 and one or more material guides 314 that feed raw material (e.g., the raw material 103) to the resin bath 320. The feed assembly 310 is illustrated in and described in further detail with reference to FIG. 4. The resin bath 320 can be positioned between the feed assembly 310 and the material shaping device 330, as shown. The resin bath 320 can receive the materials from the feed assembly 310 and coat the materials in resin (e.g., the resin 122). The material shaping system 300 can also include a reservoir 322 that can store and deliver the resin to the resin bath 320 as needed. The resin bath 320 is illustrated in and described in further detail with reference to FIG. 5.

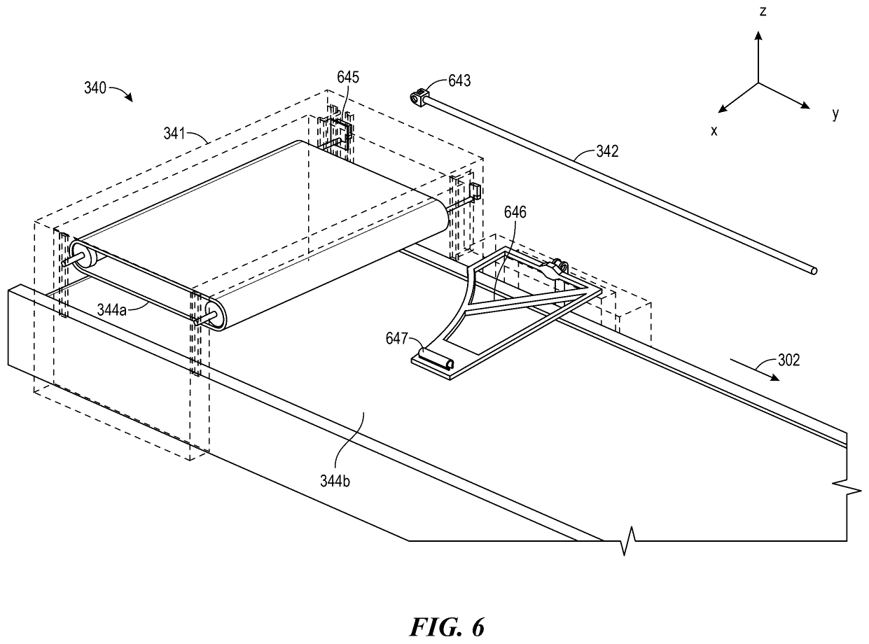

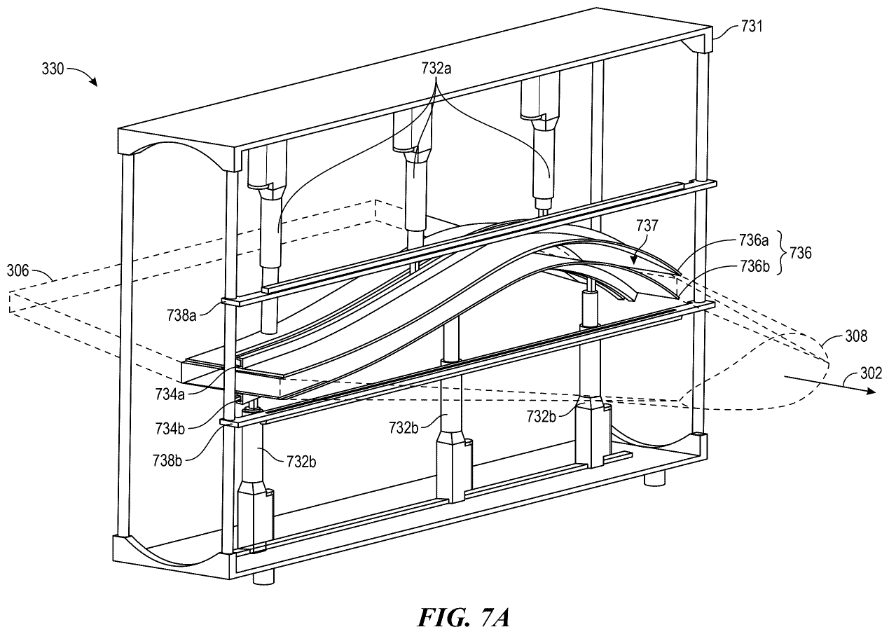

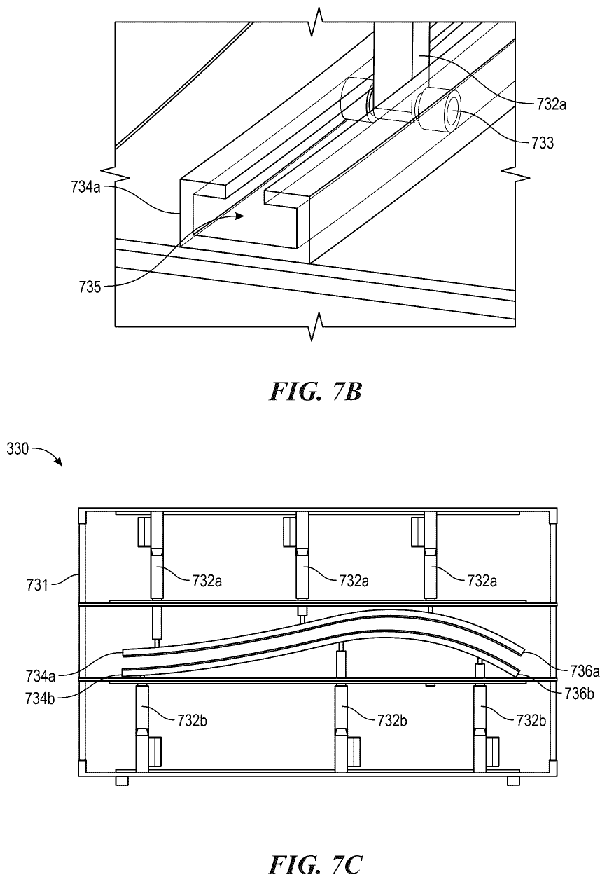

The material shaping device 330 can be positioned between the resin bath 320 and the material moving assembly 340. The material shaping device 330 can receive the resin-infused, resin-impregnated, or resin-coated material 306 from the resin bath 320, shape the material 306 into a desired structure 308, and output the desired structure 308 towards the material moving assembly 340. The material shaping device 330 is illustrated in and described in further detail with reference to FIGS. 7A-7C. The material moving assembly 340 can be positioned downstream of the material shaping device 330 and move (e.g., pull) the desired structure 308 therefrom. The material moving assembly 340 can include a frame 341, a gripper 342, a first conveyor 344a, and a second conveyor 344b. The material moving assembly 340 is illustrated in and described in further detail with reference to FIG. 6. The controller 350 can control operation of components of the feed assembly 310 (e.g., the material guides 314), the material shaping device 330, and/or the material moving assembly 340.

FIG. 4 is a perspective view of the feed assembly 310, configured in accordance with embodiments of the present technology. The feed assembly 310 can comprise a creel system. As shown, the feed assembly 310 can include the one or more spool frames 311, one or more spools 412 (only one of which is shown for illustrative purposes), and the one or more material guides 314. The spool frames 311 and the material guides 314 can be supported on legs or other support structures. In the illustrated embodiment, each spool frame 311 includes a plurality of spool support pairs 413 (e.g., protrusions) arranged in two rows. Each spool 412 can be shaped and sized to fit and extend vertically between each spool support pair 413. In other embodiments, the spool frames 311 can support the spools 412 in other configurations (e.g., including fewer or more rows, supporting the spools 412 horizontally).

Each material guide 314 can include a plurality of apertures 416 arranged in a grid pattern. The material guides 314 can receive individual portions or strands of the material (e.g., fiber strands of the raw material) in one or more of the apertures 416 to ensure that the strands are fed to the resin bath 320 in the direction 302 in an organized fashion and without being tangled. In some embodiments, the material guides 314 can be actuated by one or more actuators 418 (shown schematically). For example, the actuators 418 can move the material guides 314 along a vertical axis (e.g., up and down) and/or rotate the material guides 314 about the vertical axis to accommodate different materials, desired fiber organizations, etc.

FIG. 5 is a perspective view of the resin bath 320, configured in accordance with embodiments of the present technology. The resin bath 320 can include a rectangular body 521 supported on legs or other support structures. In other embodiments, the resin bath 320 can include bodies of other shapes (e.g., cylindrical). The resin bath 320 can include one or more inlets 524, an outlet 526, an interior or cavity 525 between the inlets 524 and the outlet 526, and one or more resin ports 528. In the illustrated embodiment, individual ones of the inlets 524 comprise apertures aligned along a line oriented perpendicular to the moving direction 302 and on the top and bottom sides of the rectangular body 521. The material (e.g., fiber strands) from the feed assembly 310 can extend into the cavity 525 via the inlets 524. The resin ports 528 can be fluidly coupled between the resin reservoir 322 (FIG. 3) and the cavity 525 such that the cavity 525 can be at least partially filled with the resin from the resin reservoir 322 as needed. For example, the resin bath 320 can include one or more sensors 527 positioned to detect a quantity of the resin (e.g., fill level percentage) in the cavity 525, and the resin can be pumped from the resin reservoir 322 upon the detected quantity falling below a predetermined threshold (e.g., a fill level percentage of 20%, 50%, 80%, etc.). In other examples, resin may be delivered upon demand (e.g., in response to a signal from the controller 350).

The material can become coated in the resin as the material travels through the cavity 525 from the inlets 524 to the outlet 526. A portion of the top surface of the resin bath 320 can be at least partially transparent (e.g., made from glass, polycarbonate, etc.), as shown, such that operators can visually inspect the coating process and/or confirm proper coating. Once the material is coated in the resin in the cavity 525, the resin-coated material can exit the resin bath 320 via the outlet 526. In the illustrated embodiment, the outlet 526 has a generally elongate, rectangular shape. In other embodiments, the outlet 526 can have other shapes (e.g., circular, square-like). The resin-coated material can then continue in the moving direction 302 towards the material shaping device 330.

FIG. 6 is a perspective, partially exploded view of the material moving assembly 340, configured in accordance with embodiments of the present technology. The material moving assembly 340 can include the frame 341 (rendered partially transparent in FIG. 6 for illustrative purposes only), the gripper 342, the first conveyor 344a, the second conveyor 344b, and a gripper mount 646. The first conveyor 344a (e.g., a conveyor belt) can be movably (e.g., slidably) coupled to the frame 341 via one or more actuators 645. The actuators 645 can be operated (e.g., by the controller 350) to move the first conveyor 344a vertically. The second conveyor 344b can remain stationary such that moving the first conveyor 344a defines a variable gap between the first and second conveyors 344a, 344b for the desired structure 308 (FIG. 3) to pass through.

The gripper 342 can comprise an elongate rod with a distal end portion 643 sized and shaped to grip onto (or otherwise configured to be coupled to) the desired structure 308. The gripper mount 646 can include a tubular portion 647 shaped and sized to hold onto the gripper 342, as shown in FIG. 3. In the illustrated embodiment, the distal end portion 643 includes two parallel plates, each with an aperture. The plates and the apertures can provide surface area for the desired structure 308 to adhere to such that the distal end portion 643 passively grips onto the desired structure 308. In other embodiments, the distal end portion 643 can include other configurations. Therefore, in some embodiments, the desired structure 308 may include an extraneous tip for the distal end portion 643 to grip onto, and is disposed of (e.g., cut off) once the material shaping process is complete.

In operation, once the distal end portion 643 of the gripper 342 has gripped onto the desired structure 308, the gripper mount 646 can be moved in the moving direction 302 relative to the frame 341 via actuators (not shown). Moving the gripper mount 646 in the moving direction 302 moves the gripper 342, and thus the desired structure 308, in the moving direction 302 away from the material shaping device 330. The first conveyor 344a and the second conveyor 344b can be operated to assist with moving the desired structure 308 in the moving direction 302. The height of the first conveyor 344a can be selected and/or dynamically adjusted to reliably move the desired structure 308 without altering its shape or damaging the desired structure 308.

FIG. 7A is a perspective view of the material shaping device 330, configured in accordance with embodiments of the present technology. The material shaping device 330 can include a frame 731, one or more first actuators 732a and one or more second actuators 732b (collectively referred to as “the actuators 732”), a first connector 734a and a second connector 734b (collectively referred to as “the connectors 734”), and a dynamic tooling member 736. The material shaping device 330 can also include at least a first stimulus member 738a and optionally a second stimulus member 738b (collectively referred to as “the stimulus members 738”). It is appreciated that the material shaping device 330 can be an example of the material shaping device 130 schematically shown in FIG. 1.

The actuators 732 (e.g., linear actuators, CNC actuators) can be mounted on the frame 731 to extend generally towards one another. In the illustrated embodiment, the frame 731 is rectangular. In other embodiments, the frame 731 can be circular, triangular, elliptical, or have any other shape (e.g., disconnected structural members). The frame 731 can be fixed relative to the environment (e.g., bolted to a floor or structure), moveable (e.g., coupled to an actuator not shown), or rotatable (e.g., about the x-axis, y-axis, and/or z-axis). In FIG. 7A, three first actuators 732a are spaced apart from one another and extend vertically between the frame 731 and the first connector 734a in a parallel manner, and three second actuators 732b are spaced apart from one another and extend vertically between the frame 731 and the second connector 734b in a parallel manner. In other embodiments, a different number of the actuators 732 can be included in the material shaping device 330. The dynamic tooling member 736 can have a long axis (e.g., extending along a length of the dynamic tooling member 736) and a short axis normal to the long axis. The connectors 734 can comprise flexible members that are coupled and conforming to the dynamic tooling member 736 along at least part of the long axis, and can deform with the dynamic tooling member 736 in response to movement of the actuators 732. In other embodiments, the axis extending along the length of the dynamic tooling member 736 is the short axis.

In the illustrated embodiment, the connectors 734 include flexible rails that slidably engage the actuators 732. More specifically, referring to FIG. 7B in which the first connector 734a is rendered partially transparent for illustrative purposes, the tip of each actuator 732 can include a pair of rollers 733, and each connector 734 can have a generally rectangular, C-shaped cross-section defining a channel 735. Thus, each connector 734 can engage the rollers 733 in the channel 735 to prevent the connector 734 from disengaging (e.g., vertically) from the actuators 732, but can allow the rollers 733 to roll within the channel 735. In some embodiments, the ends of each connector 734 are closed to prevent the rollers 733 from sliding off of the connectors 734. In some embodiments, the movement of the rollers 733 along the connectors 734 is restricted or limited (e.g., via stoppers in the connectors 734).

Referring back to FIG. 7A, the dynamic tooling member 736 can include (i) a first sheet 736a coupled to a bottom surface of the first connector 734a and (ii) a second sheet 736b coupled to a top surface of the second connector 734b. The first sheet 736a and the second sheet 736b can be spaced apart from one another such that the inner surfaces of the first sheet 736a and the second sheet 736b together define at least part of a gap or opening 737 of the dynamic tooling member 736. The connectors 734 and/or the first and second sheets 736a, 736b can be made from polymers, such as fluoropolymers (e.g., polytetrafluoroethylene (PTFE), fluorinated ethylene propylene (FEP), perfluoroalkoxy alkanes (PFA)), elastomers (e.g., silicone, polyurethane, nylons, styrene-butadiene-styrene rubber, natural rubber, vulcanized butyl rubber), other flexible material (e.g., polyethylene, polypropylene, polycarbonate, acrylonitrile butadiene styrene copolymer, styrene-butadiene-styrene block copolymer), metal, or combinations thereof. In some embodiments, the first and second connectors 734a, 734b and the corresponding first and second sheets 736a, 736b are integrally formed. In some embodiments, the connectors 734 and the first and second sheets 736a, 736b are coupled via fusing, welding, fasteners (e.g., low-profile bolts with low-profile heads in the opening 737), and/or other coupling mechanisms. The connectors 734 and/or the sheets of the dynamic tooling member 736 can include elongated holes to allow fasteners therein to move, allowing the connectors 734 and the dynamic tooling member 736 to slide relative to one another as needed.

The actuators 732 can be coupled to the dynamic tooling member 736 such that the first actuators 732a are coupled to an outer surface of the first sheet 736a and the second actuators 732b are coupled to an outer surface of the second sheet 736b. The dynamic tooling member 736 can extend in a first direction between opposing ends of the material shaping device 330 (e.g., in a direction along the travel direction 302, and the actuators 732 can extend in a second direction normal to the first direction. Moreover, in the illustrated embodiment, each of the first and second sheets 736a, 736b extends in both downstream and upstream directions from the connectors 734. The portions of the first and second sheets 736a, 736b extending upstream can define a pre-shaping zone, and the portions of the first and second sheets 736a, 736b extending downstream can define a stimulus application zone. The length of the dynamic tooling member 736 along the travel direction 302 may be determined upon a balancing of a greater rate of stimulus application, which can be achieved by increasing the length, and a greater resolution of the material shape (e.g., more “slices”), which can be achieved by decreasing the length. For example, in some embodiments, the first and second sheets 736a, 736b do not include the portions that extend downstream and/or upstream.

The stimulus members 738 can be coupled to the frame 731 and positioned (i) distal to the actuators 732 and (ii) above or below the dynamic tooling member 736. As the material 306 passes distally through the opening 737, the stimulus members 738 can apply a stimulus (e.g., heat, light, sound waves, electromagnetic stimulation such as infrared or radio frequency heating, etc.) to physically and/or chemically alter the material (e.g., resin-coated material) passing through the opening 737 of the dynamic tooling member 736. In other embodiments, the position of the stimulus member 738 can be within the dynamic tooling member 736, at the downstream end of the dynamic tooling member 736, outside of or surrounding the dynamic tooling member 736, or away from the dynamic tooling member 736 but positioned so that its stimulus (e.g., light) is provided to the material as it passes through or exits the dynamic tooling member 736. In some embodiments, the dynamic tooling member 736 comprises a stimulus-transparent material, meaning that the dynamic tooling member 736 is made from a material that allows the stimulus to be applied (e.g., heat, light, sound waves, electromagnetic stimulation such as infrared or radio frequency heating, etc.) to pass therethrough at a sufficient degree to chemically alter the material passing through the opening 737 at a sufficient rate. In some embodiments, the stimulus member 738 can cure the resin in no more than 10 milliseconds, 50 milliseconds, 100 milliseconds, 500 milliseconds, a second, 3 seconds, 5 seconds, 10 milliseconds-5 seconds, or other values. In some embodiments, the stimulus member 738 can trigger frontal polymerization that propagates through the thickness of the material (e.g., in a direction generally perpendicular to the travel direction) at a rate of at least 0.1 millimeters per second (mps), 1 mps, 5 mps, 10 mps, 20 mps, 50 mps, 0.1-50 mps, or other values.

In some embodiments, the stimulus members 738 can include infrared lamps positioned to apply stimulus in the form of infrared radiation that can facilitate heating and/or photoactivation of the portion of the material passing through the opening 737. In some embodiments, the first and second sheets 736a, 736b can be at least partially transparent, translucent, or otherwise conducive to the stimulus application such that the infrared radiation can reach the material while the material is still sandwiched between the first and second sheets 736a, 736b. In other embodiments, the stimulus members 738 can include devices configured to provide other forms of stimuli (e.g., heat, light, sound waves, electromagnetic stimulation such as infrared or radio frequency heating, etc.). For example, in some embodiments, the stimulus member 738 comprises one or more heating elements configured to radiate heat that can cure and thereby solidify the portion of the resin material passing through the opening 737 of the dynamic tooling member 736. The heater can heat the outer surface of the dynamic tooling member 736 to at least 30° C., 50° C., 100° C., 200° C., 300° C., 400° C., 500° C., 30-500° C., or other values. In some embodiments, the stimulus member 738 comprises a heated fluid that flows through a channel within or positioned adjacent to the dynamic tooling member 736. In some embodiments, the stimulus member 738 comprises a light source (e.g., infrared, ultraviolet, visible light, laser) that can heat the dynamic tooling member 736 and/or the material directly.

Referring next to FIG. 7C, the three first actuators 732a are not vertically aligned with the three second actuators 732b. This allows the six illustrated actuators 732 to define six distinct, discrete points along the length of the dynamic tooling member 736. A greater number of distinct, discrete points along the length of the dynamic tooling member 736 can enable a finer control of the shape of the dynamic tooling member 736.

Referring to FIGS. 7A-7C together, in operation, the material moving assembly 340 (FIGS. 3 and 6) can move (e.g., pull) the material (e.g., fibers infused with a resin) through the opening 737 between the first and second sheets 736a, 736b. As shown in FIG. 7A, before passing through the opening 737, the resin-coated material 306 has a generally constant cross-section generally corresponding to the shape of the outlet 526 of the resin bath 320 (FIG. 5). As the material passes though the opening 737, the actuators can be independently controlled (e.g., via the controller 350) to adjust the shape of the connectors 734, and thus the shapes of the dynamic tooling member 736 and the opening 737. As the actuators 732 move, the rollers 733 on the actuators 732 can allow the connectors 734 to take on various curvatures without being constrained laterally by the actuators 732.

In some embodiments, the fast-curing nature of the resin material enables the material shaping device 330 to continuously define and alter the cross-section of the material. As the material passes though the opening 737, the shape of the opening 737 can define the shape imparted to a specific cross-section, or “slice,” of the material passing therethrough at any given moment. In some embodiments, the material is a liquid or a liquid-impregnated solid (e.g., wetted fibers) when upstream of the dynamic tooling member 736 (e.g., before going through the opening 737) and is a solid, majority-solid, or has a solidified outer skin that was exposed to or in contact with the stimulus member 738 when downstream of the dynamic tooling member 736 (i.e., after going through the opening 737). For example, the material can include a resin and the stimulus member 738 can cure the resin such that the desired structure 308 is chemically altered and solidified, and can thereby retain the imparted shape.

Therefore, by adjusting the shape of the opening 737 continuously as the material passes therethrough, the desired structure 308 can have varying cross-sections (e.g., different “slices” can have different cross-sections). By controlling the cross-section and travel speed of the material, the material shaping device 330 can manufacture structures with complex geometries in a relatively short period of time. It will be appreciated that changing, altering, or imparting a “shape” of the dynamic tooling member or the opening thereof, as used herein, includes changing, altering, or imparting a shape, position, and/or orientation of the dynamic tooling member or the opening thereof.

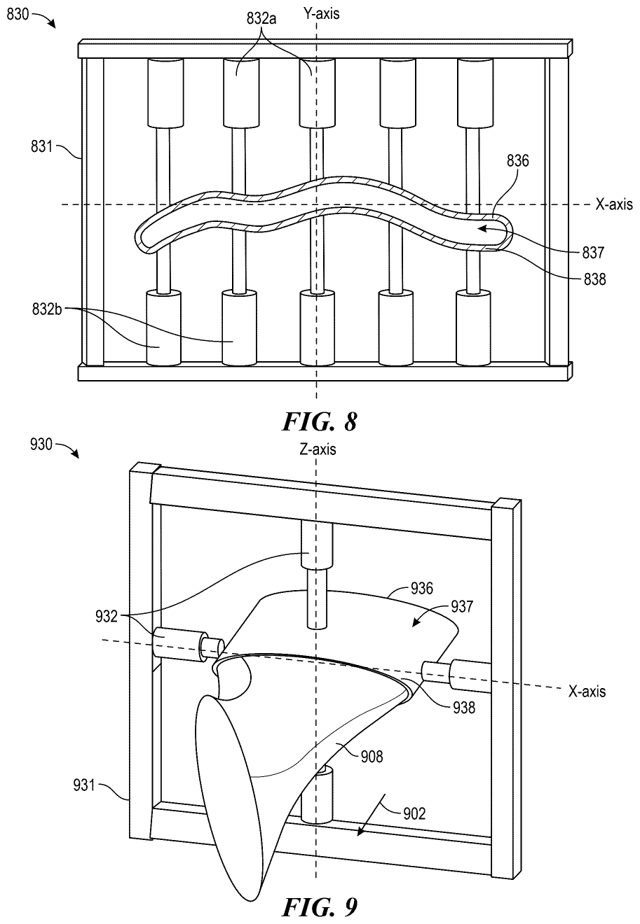

FIG. 8 is a front view of another material shaping device 830, configured in accordance with embodiments of the present technology. The material shaping device 830 can include a frame 831, a plurality of first actuators 832a and a plurality of second actuators 832b (collectively referred to as “the actuators 832”), a dynamic tooling member 836, and one or more stimulus members 838.

The actuators 832 can be coupled to the frame 831 and positioned to extend vertically towards the dynamic tooling member 836. The actuators 832 can also be spaced apart from one another such that the actuators 832 are coupled to different portions of the dynamic tooling member 836. The actuators 832 can be coupled to the dynamic tooling member 836 via, e.g., adhesives, fitting (e.g., friction fitting), fasteners, being embedded in the dynamic tooling member 836, kinematic pairing (e.g., prismatic joint, ball and socket joint, planar joint), etc. The dynamic tooling member 836 can form a closed loop defining an opening 837 through which material can be passed. The stimulus member 838 can be positioned adjacent to or at least partially embedded in the dynamic tooling member 836, and can have a shape identical, similar, complementary, or adjacent to the dynamic tooling member 836.

FIG. 9 is a front view of another material shaping device 930, configured in accordance with embodiments of the present technology. The material shaping device 930 can include a frame 931, a plurality of actuators 932, a dynamic tooling member 936, and one or more stimulus members 938.

The actuators 932 can be coupled to the frame 931 and positioned to extend omnidirectionally towards the dynamic tooling member 936. In FIG. 9, the frame 931 has a generally rectangular shape and four actuators 932 extend from each of the four sides of the frame 931. The actuators 932 can be coupled to the dynamic tooling member 936 via, e.g., adhesives, fitting (e.g., friction fitting), fasteners, being embedded in the dynamic tooling member 936, etc. The dynamic tooling member 936 can form a closed loop defining an opening 937 through which material 908 can be passed in the travel direction 902. The stimulus member 938 can be positioned adjacent to or at least partially embedded in the dynamic tooling member 936, and can have a shape identical, similar, complementary, or adjacent to the dynamic tooling member 936.

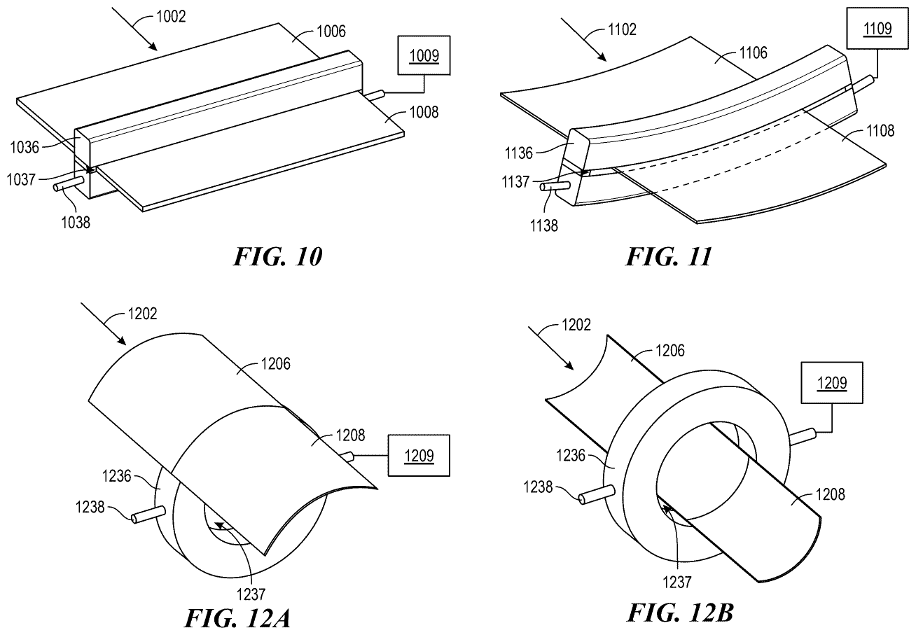

FIGS. 10-12B are perspective views of various examples of dynamic tooling members, configured in accordance with embodiments of the present technology. Referring first to FIG. 10, the dynamic tooling member 1036 comprises a linear or straight block with an opening 1037 in the form of a narrow, straight slit. A stimulus member 1038 (e.g., a heating element) can be embedded in the dynamic tooling member 1036. During operation, a resin-coated material 1006 can be passed through the opening 1037 in a travel direction 1002, and the stimulus member 1038 can receive power from a power source 1009 to apply a stimulus (e.g., heat, light, sound waves, electromagnetic stimulation such as infrared or radio frequency heating) to the material 1006 to form a desired structure 1008.

Referring next to FIG. 11, the dynamic tooling member 1136 comprises a curved block with an opening 1137 in the form of a narrow, curved slit. A stimulus member 1138 (e.g., a heating element) can be embedded in the dynamic tooling member 1136. During operation, a resin-coated material 1106 can be passed through the opening 1137 in a travel direction 1102, and the stimulus member 1138 can receive power from a power source 1109 to apply a stimulus (e.g., heat, light, sound waves, electromagnetic stimulation such as infrared or radio frequency heating) to the material 1106 to form a desired structure 1108. In some embodiments, a single dynamic tooling member can transition between the straight geometry illustrated in FIG. 10 and the curved geometry illustrated in FIG. 11 (e.g., via actuators).

Referring next to FIGS. 12A and 12B, the dynamic tooling member 1236 comprises a ring with an opening 1237 with a circular cross-section. A stimulus member 1238 (e.g., a heating element) can be embedded in the dynamic tooling member 1236. During operation, a resin-coated material 1206 can be passed either over the dynamic tooling member 1236 (as shown in FIG. 12A) or through the opening 1237 (as shown in FIG. 12B) in a travel direction 1202, and the stimulus member 1238 can receive power from a power source 1209 to apply a stimulus (e.g., heat, light, sound waves, electromagnetic stimulation such as infrared or radio frequency heating) to the material 1206 to form a desired structure 1208.

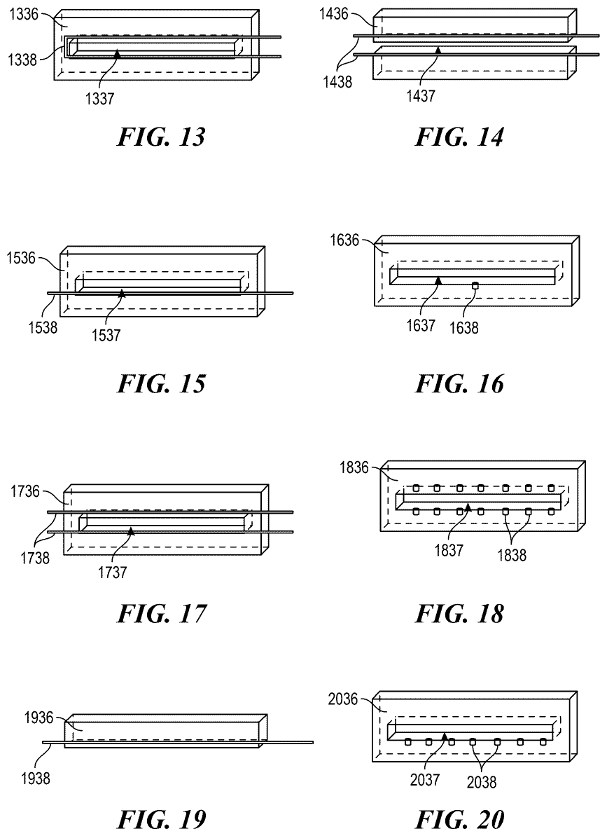

FIGS. 13-22 are front views of various examples of dynamic tooling members, configured in accordance with embodiments of the present technology. As will be described below, the geometry of the stimulus member can vary depending on or regardless of the geometry of dynamic tooling member. It will be appreciated that the dynamic tooling members and the stimulus members described with reference to FIGS. 13-22 can generally correspond to and/or include the features described above. It will also be appreciated that the stimulus members 430 can have geometries different from the illustrated examples. It is further appreciated that the illustrated stimulus members 430 can be any one of or a combination of the various stimulus members described above (e.g., heaters, heated fluids, light sources, etc.).

FIG. 13 illustrates a dynamic tooling member 1336 with a single, unitary structure and an opening 1337. The illustrated stimulus member 1338 is a single unit (e.g., a wire, a heated fluid flowing through a single channel) that extends adjacent to and around the opening 1337. In some embodiments, the stimulus member 1338 is positioned proximate to the opening 1337 in order to maximize the effectiveness and/or efficiency of the stimulus member 1338 when in operation.

FIG. 14 illustrates a dynamic tooling member 1436 with two disjointed structures that define a gap 1437 therebetween. The illustrated stimulus member 1438 includes two separate units that each extend adjacent to and along the gap 1437.

FIG. 15 illustrates a dynamic tooling member 1536 with a single, unitary structure and an opening 1537. The illustrated stimulus member 1538 is a single unit that extends adjacent to and along one side of the opening 1537.

FIG. 16 illustrates a dynamic tooling member 1636 with a single, unitary structure and an opening 1637. The illustrated stimulus member 1638 is a single unit positioned adjacent to the opening 1637 such that the stimulus may be provided from a single point (e.g., as opposed to from a continuous line as illustrated in FIGS. 13-15). In some embodiments, the illustrated stimulus member 1638 can be coupled to a power supply or pump via a line (not shown) extending away from the opening 1637.

FIG. 17 illustrates a dynamic tooling member 1736 with a single, unitary structure and an opening 1737. The illustrated stimulus member 1738 includes two separate units that each extend adjacent to and along the opening 1737.

FIG. 18 illustrates a dynamic tooling member 1836 with a single, unitary structure and an opening 1837. The illustrated stimulus member 1838s include a plurality of disjointed units positioned adjacent to and spread along two sides of the opening 1837 such that stimuli may be provided from multiple points instead of from a continuous line. In some embodiments, the illustrated stimulus members 1838 can be coupled to a power supply or pump via one or more lines (not shown) extending away from the opening 1837.

FIG. 19 illustrates a dynamic tooling member 1936 with a single, unitary structure without an opening. Thus, the material may move above or below the illustrated structure. The illustrated stimulus member 1938 is a single unit that extends adjacent to and along one side of the dynamic tooling member 1936.

FIG. 20 illustrates a dynamic tooling member 2036 with a single, unitary structure and an opening 2037. The illustrated stimulus members 2038 include a plurality of disjointed units positioned adjacent to and spread along one side of the opening 2037 such that stimuli may be provided from multiple points instead of from a continuous line. In some embodiments, the illustrated stimulus members 2038 can be coupled to a power supply or pump via one or more lines (not shown) extending away from the opening 2037.

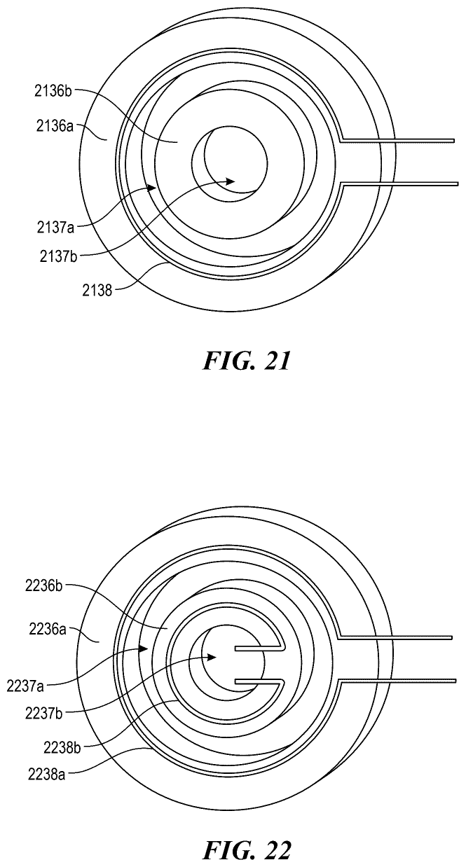

FIG. 21 illustrates a first dynamic tooling member portion 2136a and a second dynamic tooling member portion 2136b. The first dynamic tooling member portion 2136a comprises a ring and the second dynamic tooling member portion 2136b comprises a smaller ring positioned within the first dynamic tooling member portion 2136. Therefore, the first and second dynamic tooling member portions 2136a, 2136b define a gap 2137a therebetween, and the second dynamic tooling member portion 2136b defines an opening 2137b. The illustrated stimulus member 2138 is a single unit that extends through and along the first dynamic tooling member portion 2136a. Moreover, the stimulus member 2138 is positioned adjacent to the gap 2137a.

FIG. 22 illustrates a first dynamic tooling member portion 2236a and a second dynamic tooling member portion 2236b. The first dynamic tooling member portion 2236a comprises a ring and the second dynamic tooling member portion 2236b comprises a smaller ring positioned within the first dynamic tooling member portion 2236. Therefore, the first and second dynamic tooling member portions 2236a, 2236b define a gap 2237a therebetween, and the second dynamic tooling member portion 2236b defines an opening 2237b. The illustrated stimulus members 2238 include a first unit that extends through and along the first dynamic tooling member portion 2236a, and a second unit that extends through and along the second dynamic tooling member portion 2236b. Moreover, the first unit of the stimulus members 2238 is positioned adjacent to the gap 2237a.

In embodiments with a stimulus member comprising two or more units (e.g., FIGS. 14, 17, 18, 20, 22), the units may be wired (e.g., in the case of heating elements) separately, in parallel, in series, etc. In some embodiments, the stimulus member may extend through one or more portions of the dynamic tooling member. For example, referring to the embodiment illustrated in FIG. 21, the stimulus member 2138 may extend around only a portion (e.g., 1/12, ⅙, ¼, ⅓, or ½) of the circumference of the first dynamic tooling member portion 2136a. In another example, again referring to the embodiment illustrated in FIG. 21, a first portion of the stimulus member 2138 may extend around only ¼ of the circumference of the first dynamic tooling member portion 2136a (e.g., 90 degrees) and a second portion of the stimulus member 2138 may extend around another ¼ of the circumference of the first dynamic tooling member portion 2136a, but spaced apart from the first portion of the stimulus member 2138.

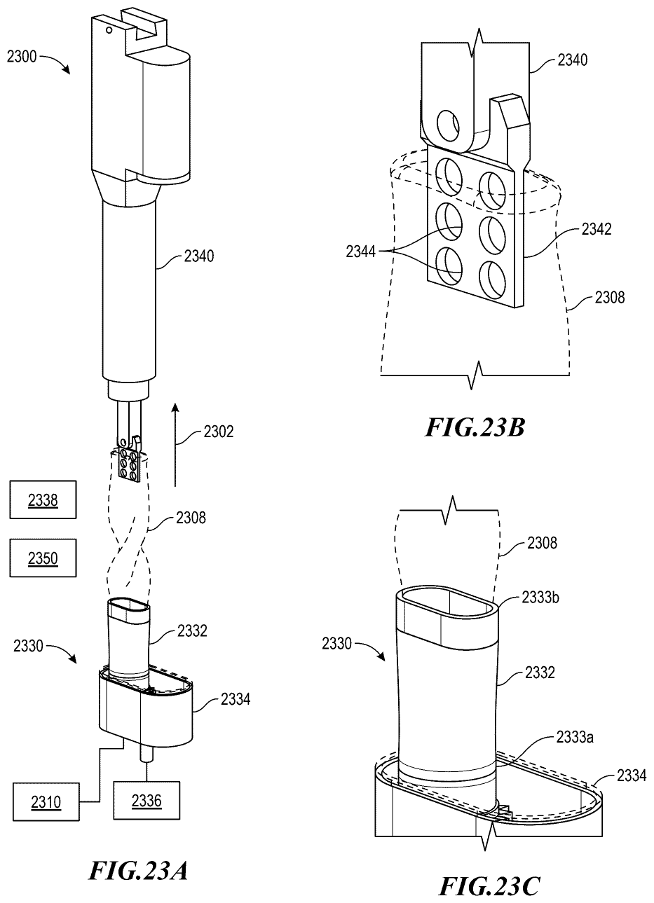

FIG. 23A is a perspective view of another material shaping system 2300, configured in accordance with embodiments of the present technology. The material shaping system 2300 can include a feed assembly 2310 (shown schematically), a material shaping device 2330, a material moving assembly 2340, a stimulus member 2338 (shown schematically), and a controller 2350 (shown schematically). The controller 2350 can be operably coupled to the components of the feed assembly 2310, the material shaping device 2330, and/or the material moving assembly 2340. As shown, the material shaping system 2300 can be operated to form a desired structure 2308 by moving material in a travel direction 2302.

The feed assembly 2310 can feed resin-coated material to the material shaping device 2330. In some embodiments, the feed assembly 2310 is generally similar or identical to the feed assembly 310 illustrated in FIGS. 3 and 4. The material shaping device 2330 can include a dynamic tooling member 2332, a housing 2334, and an actuator 2336 (shown schematically; e.g., a motor). The actuator 2336 can be coupled to rotate the tooling member 2332 via the housing 2334. The housing 2334 can enclose gears, wheels, rollers, or other components that enable rotation of the tooling member 2332 by the actuator 2336. These components can be coupled to the tooling member 2332 via welding, fasteners, adhesives, fitting (e.g., friction fitting), or other coupling mechanisms.

Referring to FIG. 23C, the tooling member 2332 can include a proximal end portion 2333a and a distal end portion 2333b. The proximal end portion 2333a can have a generally circular cross-section to enable rotation of the tooling member 2332 via gears included in the housing 2334. In other embodiments, the proximal end portion 2333a can have other shapes and can be rotated via wheels, rollers, etc. included in the housing 2334. The distal end portion 2333b has an opening with, in the illustrated embodiment, an oblong cross-section. In other embodiments, the distal end portion 2333b can have other shapes such as circular, elliptical, crescent, Reuleaux polygon, triangular, rectangular, trapezoidal, irregular quadrilateral, a compound shape (e.g., a keyhole), one of the geometries illustrated in FIGS. 10-22, or a non-standard shape. The tooling member 2332 can be made from a rigid material (e.g., metal, glass), a flexible material (e.g., polytetrafluoroethylene, fluorinated ethylene propylene, perfluoroalkoxy alkanes, polyethylene, polypropylene, polycarbonate, acrylonitrile butadiene styrene copolymer, styrene-butadiene-styrene block copolymer, spring steel), an elastomeric material (e.g., silicone, polyurethane, nylons, styrene-butadiene-styrene rubber, natural rubber, vulcanized butyl rubber, nitinol), or combinations thereof.

Referring to FIG. 23B, the material moving assembly 2340 includes a tip 2342 in the shape of a rectangular plate including a plurality of circular apertures 2344. The rectangular plate and the apertures 2344 of the tip 2342 can provide surface area for the desired structure 2308 to adhere to such that the tip 2342 passively grips onto the desired structure 2308. In other embodiments, the tip 2342 of the material moving assembly 2340 can have other configurations.

The stimulus member 2338 can be positioned at or near the tooling member 2332. As discussed above with respect to stimulus members generally, the stimulus member 2338 can apply a stimulus (e.g., heat, light, sound waves, electromagnetic stimulation such as infrared or radio frequency heating) to physically and/or chemically alter the material. In some embodiments (e.g., embodiments in which the stimulus member 2338 emits heat or heated airflow), the stimulus member 2338 can be positioned at least 1 mm, 5 mm, 1 cm, 10 cm, or other distances downstream of the distal end portion 2333b. In some embodiments (e.g., embodiments in which the stimulus member 2338 emits light), the stimulus member 2338 can be positioned upstream of the distal end portion 2333b such that the stimulus may reach the material while the material is in the tooling member 2332 (e.g., which may be at least partially transparent). In some embodiments, the stimulus member 2338 may be coupled to the rotating components in the housing 2334 in order to maintain a constant orientation and distance relative to the material.

Referring back to FIG. 23A, in operation, as the feed assembly 2310 feeds material to the material shaping device 2330, the actuator 2336 can be operated (e.g., via the controller 2350) to re-position (e.g., translate) and/or rotate the tooling member 2332 about an axis defined by one of the gears included in the housing 2334. As the material moving assembly 2340 moves (e.g., pulls) the desired structure 2308 in the travel direction 2302, the stimulus member 2338 can apply a stimulus (e.g., heat, light, sound waves) to the material exiting the tooling member 2332 to form the desired structure 2308. Consequently, the shape of the distal end portion 2333b is continuously imparted to different “slices” of the material. Although the shape of the distal end portion 2333b remains constant, translation and/or rotation of the tooling member 2332 can be controlled to create a desired three-dimensional shape (e.g., the twisted shape illustrated in FIG. 23A, a serpentine shape by translating the tooling member 2332 left and right). Therefore, the shape of the tooling member 2332 can be preselected, and the rotation speed and pattern of the actuator 2336 can be controlled based on the desired three-dimensional shape. In embodiments in which the tooling member 2332 is made from a flexible or elastomeric material, the tooling member 2332 may be simultaneously rotated by the actuator 2336 and reshaped by actuators (not shown, but analogous to the actuators 732 illustrated in FIG. 7A) to produce a desired structure that exhibits both rotational twisting and varying cross-sections. It will be appreciated that changing, altering, or imparting a “shape” of the dynamic tooling member or the opening thereof, as used herein, includes changing, altering, or imparting a shape, position, and/or orientation of the dynamic tooling member or the opening thereof.

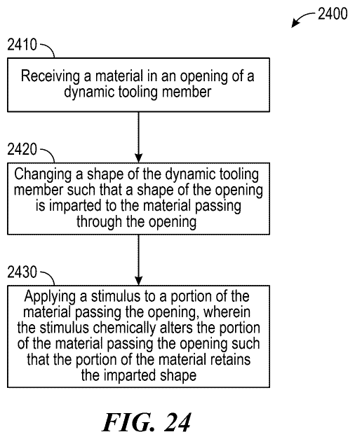

FIG. 24 is a flowchart illustrating a method 2400 of shaping a material, configured in accordance with embodiments of the present technology. While the method 2400 is described below with reference to the embodiments described and/or illustrated herein, it will be appreciated that the method 2400 can be performed in accordance with other embodiments of the present technology. Also, while process portions of the method 2400 are described in a particular order, in some embodiments, one or more process portions can be performed in a different order than presented or omitted, and the method 2400 may include additional steps not necessarily described in detail herein.

The method 2400 can begin by receiving a material in an opening (e.g., the opening 737, the opening 837) of a dynamic tooling member (e.g., the dynamic tooling member 736, 836, 2332) (process portion 2402). In some embodiments, the material is received from a feed assembly (e.g., the feed assembly 110, 310), a resin bath (e.g., the resin bath 120, 320), and/or a reservoir (e.g., the reservoir 220). The feed assembly can include a creel system, spools (e.g., the spools 112, 412), and/or material guides (e.g., the material guides 114, 314). In embodiments including a resin bath, the method 2400 can further include, prior to receiving the material in the gap or opening of the dynamic tooling member, immersing fibers or other materials in a resin. Thus, the material received in the gap or opening of the dynamic tooling member comprises resin-coated fibers. In embodiments including a reservoir, a plunger (e.g., the plunger 214) can be controlled by an actuator (e.g., the actuator 212) to pressurize the reservoir and push the material towards the dynamic tooling member.

The method 2400 can continue by changing a shape of the opening of the dynamic tooling member (process portion 2404). As the material passes through the gap or opening of the dynamic tooling member, the shape of the opening is imparted to the material (or a portion or “slice” thereof) passing through the opening. In some embodiments, the shape of the opening can be dynamically changed by actuators (e.g., the actuators 732, CNC actuators, the actuator 2336) coupled to the dynamic tooling member.

The method 2400 can continue by applying a stimulus to the portion of the material passing through or beyond the opening (process portion 2406). The stimulus can chemically alter the portion of the material passing through the opening such that the portion of the material retains the imparted shape. It will be appreciated that changing, altering, or imparting a “shape” of the dynamic tooling member or the opening thereof, as used herein, includes changing, altering, or imparting a shape, position, and/or orientation of the dynamic tooling member or the opening thereof. In some embodiments, applying the stimulus comprises applying at least one of heat, light, sound waves, or electromagnetic stimulation. In embodiments in which the material includes resin-coated fibers, the stimulus can cure the resin of the resin-coated fibers.

In some embodiments, the method 2400 can further include moving, continuously or intermittently, the material through and away from the dynamic tooling member. For example, a material moving assembly (e.g., the material moving assembly 140, 340, 2340) can include a gripper (e.g., the gripper 342) providing sufficient surface area for the material to adhere to, and the gripper can be actuated to move the material.

As aforementioned, embodiments of the present technology provide several advantages and improvements relative to related conventional technology. For example, unlike related conventional technologies, embodiments of the present technology do not require molds and other static tooling, which can be extremely expensive and time-consuming to obtain, and which consequently slow production and add friction to design iterations. Embodiments of the present technology can also produce structures of various materials (e.g., plastics) with complex geometries by dynamically, rapidly, and continuously defining and fixing cross-sectional shapes along a length of the material. Chemically altering portions of the material can fix cross-sectional shapes of the material more rapidly compared to, for example, conventional methods of curing reactive liquids into a polymer or solidifying molten plastic via cooling. Moreover, embodiments of the present technology can include a high level of automation, significantly reducing the manual labor needed and the high defect rates and operational expenditures associated with manual labor. Furthermore, embodiments of the present technology can mitigate climate change by accelerating the production of structures such as wind turbine blades, and by producing structures in a generally more environmentally friendly manner, such as by utilizing resins that cure with minimal energy input and/or using recyclable materials.

As an example, to produce molds for wind turbine blades, conventional technology can require molds made by resin transfer molding, which requires prefabrication of a foam “plug” to template the mold's shape. This plug can often be a major bottleneck in updating wind turbine designs, as they can take 6 months or longer to acquire. By contrast, embodiments of the present technology can be used to produce mold shells without long lead times because they do not require custom tooling.

As another example point of comparison, embodiments of the present technology can be used to produce vertical axis wind turbines more easily and with lower cost compared to conventional technology. Vertical axis wind turbines are an emerging form of technology, and are expected to produce clean energy at a lower cost than horizontal axis wind turbines due to their simpler design and lower maintenance requirements. However, vertical-axis wind turbines can be difficult to manufacture due to their size and axial rotation (“twist”) along the length of the blade. As discussed above herein, embodiments of the present technology can be used to produce large structures with “twisted” geometries, enabling low-cost production of such complex parts.

As yet another example, embodiments of the present technology can be used to produce structural elements for infrastructure more easily and cheaply compared to conventional technology. Composites are attractive materials for structural elements (e.g., I-beams, rebars, etc.) due to their high strength, low weight, and corrosion resistance. However, conventional technology can only produce linear composite structural elements, and post-production bending or shaping of composites is not generally possible. By contrast, embodiments of the present technology can enable the direct production of bent, curved, and/or tapered elements.

### III. CONCLUSION

It will be apparent to those having skill in the art that changes may be made to the details of the above-described embodiments without departing from the underlying principles of the present technology. In some cases, well known structures and functions have not been shown or described in detail to avoid unnecessarily obscuring the description of the embodiments of the present technology. Although steps of methods may be presented herein in a particular order, alternative embodiments may perform the steps in a different order. Similarly, certain aspects of the present technology disclosed in the context of particular embodiments can be combined or eliminated in other embodiments. Furthermore, while advantages associated with certain embodiments of the present technology may have been disclosed in the context of those embodiments, other embodiments can also exhibit such advantages, and not all embodiments need necessarily exhibit such advantages or other advantages disclosed herein to fall within the scope of the technology. Accordingly, the disclosure and associated technology can encompass other embodiments not expressly shown or described herein, and the invention is not limited except as by the appended claims.

Throughout this disclosure, the singular terms “a,” “an,” and “the” include plural referents unless the context clearly indicates otherwise. Additionally, the term “comprising,” “including,” and “having” should be interpreted to mean including at least the recited feature(s) such that any greater number of the same feature and/or additional types of other features are not precluded.

Reference herein to “one embodiment,” “an embodiment,” “some embodiments” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics may be combined in any suitable manner in one or more embodiments.

Unless otherwise indicated, all numerical parameters set forth in the following specification and attached claims are approximations that may vary depending upon the desired properties sought to be obtained by the present technology. At the very least, and not as an attempt to limit the application of the doctrine of equivalents to the scope of the claims, each numerical parameter should at least be construed in light of the number of reported significant digits and by applying ordinary rounding techniques. Additionally, all ranges disclosed herein are to be understood to encompass any and all subranges subsumed therein. For example, a range of “1 to 10” includes any and all subranges between (and including) the minimum value of 1 and the maximum value of 10, i.e., any and all subranges having a minimum value of equal to or greater than 1 and a maximum value of equal to or less than 10, e.g., 5.5 to 10.

The disclosure set forth above is not to be interpreted as reflecting an intention that any claim requires more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

The present technology is illustrated, for example, according to various aspects described below as numbered clauses (1, 2, 3, etc.) for convenience. These are provided as examples and do not limit the present technology. It is noted that any of the dependent clauses may be combined in any combination, and placed into a respective independent clause. The other clauses can be presented in a similar manner.
1. An apparatus for shaping a material, comprising:
   a dynamic tooling member having an outer surface and an opening, wherein a shape of the opening is defined at least in part by the outer surface, and wherein the dynamic tooling
   member is configured to receive the material through the opening;
a plurality of actuators coupled to the dynamic tooling member, wherein the actuators are configured to dynamically change a shape of the dynamic tooling member along an x-axis and/or a y-axis perpendicular to the x-axis; and
   a stimulus member coupled to the dynamic tooling member, wherein the stimulus member is configured to provide a stimulus to a portion of the material passing through the opening of the dynamic tooling member to chemically alter the material,
   wherein, in operation, the shape of the opening is imparted to the portion of the material passing through the opening of the dynamic tooling member.
2. The apparatus of any one of the clauses herein, wherein the stimulus member comprises a heater and heat from the stimulus member is configured to solidify the portion of the material and/or an outer surface of the material passing through the dynamic tooling member in less than a second, three seconds, or five seconds.
3. The apparatus of any one of the clauses herein, wherein the stimulus member is a heater configured to heat the outer surface of the dynamic tooling member such that the portion of the material passing through the opening solidifies at a rate of at least 0.1 millimeters/second through a thickness of the material.
4. The apparatus of any one of the clauses herein, wherein the stimulus member is a heater configured to heat an outer surface of the dynamic tooling member such that the outer surface of the portion of the material passing through the opening undergoes frontal polymerization.
5 The apparatus of any one of the clauses herein, wherein the stimulus member is a heater configured to heat an outer surface of the dynamic tooling member such that a solidified skin is formed on the material in less than a second, three seconds, or five seconds, and the material solidifies at a rate of at least 0.1 millimeters/second through a thickness of the material.
6. The apparatus of any one of the clauses herein, wherein the material upstream of the opening is a liquid and the material downstream of the opening is a solid.
7. The apparatus of any one of the clauses herein, wherein the stimulus member is a heater coupled to a power source, and wherein the stimulus member is positioned adjacent to the dynamic tooling member such that heat from the heater is at least partially absorbed by the portion of the material passing through the opening.
8. The apparatus of any one of the clauses herein, wherein the stimulus member is a heater configured to heat the outer surface of the dynamic tooling member to at least 30° C., 50° C., 100° C., 200° C., 300° C., 400° C., 500° C., or within a range of 30-500° C.
9. The apparatus of any one of the clauses herein, wherein the stimulus member comprises a heated fluid, the apparatus further comprising a channel positioned adjacent the dynamic tooling member and configured to receive the heated fluid.
10. The apparatus of any one of the clauses herein, wherein the stimulus member comprises a laser source configured to heat the dynamic tooling member.
11. The apparatus of any one of the clauses herein, wherein the stimulus member is a light source configured to facilitate photoactivation of the portion of the material passing through the dynamic tooling member, and wherein the stimulus is light.
12. The apparatus of any one of the clauses herein, wherein the dynamic tooling member comprises at least one of silicones, polyurethanes, nylons, and rubbers including styrene-butadiene-styrene rubber, natural rubber, and vulcanized butyl rubber.
13. The apparatus of any one of the clauses herein, wherein the dynamic tooling member comprises many small metal components that are joined together with many degrees of freedom to approximate a flexible monolithic material.
14. The apparatus of any one of the clauses herein, wherein the outer surface of the dynamic tooling member encloses the opening.
15. A system for shaping a material, comprising:
   a dynamic tooling member having an outer surface and opening, wherein a shape of the opening is defined at least in part by the outer surface, and wherein the dynamic tooling member is configured to receive the material through the opening;
   a movement assembly configured to move the material through the opening of the dynamic tooling member; and
   a stimulus member coupled to the dynamic tooling member, wherein the stimulus member is configured to provide a stimulus to a portion of the material passing through the opening of the dynamic tooling member to chemically alter the material,
   wherein, in operation, the shape of the opening is imparted to the portion of the material passing through the opening of the dynamic tooling member.
16. The system of any one of the clauses herein, wherein the movement assembly comprises a creel system positioned upstream of the dynamic tooling member and configured to feed the material into the opening of the dynamic tooling member.
17. The system of any one of the clauses herein, wherein the movement assembly comprises a plurality of grippers positioned downstream of the dynamic tooling member and configured to pull the material away from the opening of the dynamic tooling member.
18. The system of any one of the clauses herein, wherein the movement assembly comprises:
   a reservoir positioned upstream of the dynamic tooling member and configured to store the material;
   a tubular member coupled between the reservoir and the dynamic tooling member; and
   a plunger coupled to an actuator and configured to pressurize the reservoir and force the material downstream through the tubular member,
   wherein the dynamic tooling member comprises a nozzle.
19. The system of any one of the clauses herein, wherein the stimulus member is a heater configured to heat the outer surface of the dynamic tooling member such that the portion of the material passing through the opening solidifies at a rate of at least 0.1 millimeters/second through a thickness of the material.
20. The system of any one of the clauses herein, wherein the stimulus member is a heater configured to heat an outer surface of the dynamic tooling member such that the outer surface of the portion of the material passing through the opening undergoes frontal polymerization.
21. The apparatus of any one of the clauses herein, wherein the stimulus member is a heater configured to heat an outer surface of the dynamic tooling member such that a solidified skin is formed on the material in less than a second, three seconds, or five seconds, and the material solidifies at a rate of at least 0.1 millimeters/second through a thickness of the material.
22 The system of any one of the clauses herein, wherein the stimulus member is a heater configured to heat the dynamic tooling member such that a solidified skin is formed on the material in less than a second, three seconds, or five seconds, and the material solidifies at a rate of at least 0.1 millimeters/second through a thickness of the material.
23. A method of shaping a material, the method comprising:
   passing the material through an opening of a dynamic tooling member;
   chemically altering a first portion of the material passing through the opening; and
   dynamically changing a shape of the opening while passing a second portion of the material through the opening, the second portion being upstream of the first portion.
24. The method of any one of the clauses herein, wherein passing the material through the opening causes the shape of the opening to be imparted to the material.
25 The method of any one of the clauses herein, wherein chemically altering the first portion of the material comprises providing a stimulus to the first portion of the material passing through the opening.
26. The method of any one of the clauses herein, wherein chemically altering the first portion of the material comprises heating the first portion of the material passing through the opening.
27. The method of any one of the clauses herein, wherein chemically altering the first portion of the material comprises passing a heated fluid through a channel within the dynamic tooling member and thereby heating the first portion of the material passing through the opening.
28. The method of any one of the clauses herein, wherein chemically altering the first portion of the material comprises applying light to the first portion of the material passing through the opening.
29. The method of any one of the clauses herein, wherein chemically altering the first portion of the material comprises positioning a heater adjacent to the dynamic tooling member such that heat from the heater raises an outer surface of the dynamic tooling member to at least 30° C., 50° C., 100° C., 200° C., 300° C., 400° C., 500° C., or within a range of 30-500° C.
30. The method of any one of the clauses herein, further comprising chemically altering the second portion of the material passing through the opening, wherein an outer surface of the first and second portions of the material are continuously chemically altered as the first and second portions pass through the opening.
31. A material shaping device, comprising:
   a dynamic tooling member including an opening, wherein the dynamic tooling member is positioned to receive a material that, in operation, passes through the opening;
   an actuator coupled to the dynamic tooling member, wherein the actuator is configured to dynamically change a shape of the opening of the dynamic tooling member; and
   a stimulus member positioned to provide a stimulus to a portion of the material passing through the opening of the dynamic tooling member,
   wherein the shape of the gap or opening of the dynamic tooling member are imparted to the portion of the material passing through the opening, and
   wherein the stimulus chemically alters the portion of the material passing through the opening such that the portion of the material retains the imparted shape.
32. The material shaping device of any one of the clauses herein, wherein the dynamic tooling member includes a polymeric material.
33 The material shaping device of any one of the clauses herein, wherein the dynamic tooling member includes a stimulus-transparent material.
34. The material shaping device of any one of the clauses herein, wherein the dynamic tooling member comprises a first polymer sheet and a second polymer sheet spaced apart from the first polymer sheet, wherein an inner surface of the first polymer sheet and an inner surface of the second polymer sheet together define at least part of the opening, wherein the actuator is a first actuator coupled to an outer surface of the first polymer sheet, and wherein the material shaping device further comprises a second actuator coupled to an outer surface of the second polymer sheet.
35. The material shaping device of any one of the clauses herein, wherein the actuator is one of a plurality of actuators configured to dynamically change the shape of the opening of the dynamic tooling member.
36 The material shaping device of any one of the clauses herein, wherein the actuators extend toward the dynamic tooling member in a plurality of directions, and wherein the actuators are coupled to a plurality of corresponding discrete points along the dynamic tooling member.
37 The material shaping device of any one of the clauses herein, wherein the actuator comprises a motor configured to change the orientation of the opening of the dynamic tooling member.
38 The material shaping device of any one of the clauses herein, wherein the stimulus member comprises a heater configured to heat at least a portion of the dynamic tooling member to a temperature between 30-250° C.
39 The material shaping device of any one of the clauses herein, wherein the material is configured to pass distally through the opening, wherein the stimulus is positioned (i) distal to the actuator and (ii) above or below the dynamic tooling member.
40. The material shaping device of any one of the clauses herein, wherein the material comprises a resin, and wherein the stimulus is positioned to cure the resin to form a thermoplastic or thermoset polymeric material.
41 The material shaping device of any one of the clauses herein, wherein the material comprises at least one of an epoxy-anhydride resin, an epoxy resin, a vinyl ether resin, a cyclic ether resin, a polyester resin, a cycloalkenyl resin, a dicyclopentadiene resin, an acrylic resin, a methacrylic resin, a methacrylamide resin, a vinyl ester resin, or a urethane resin.
42. The material shaping device of any one of the clauses herein, wherein the material comprises fibers infused or coated with a resin.
43 The material shaping device of any one of the clauses herein, wherein the dynamic tooling member extends in a first direction between opposing ends of the material shaping device, and wherein the actuator extends in a second direction normal to the first direction.
44. The material shaping device of any one of the clauses herein, wherein the stimulus member comprises a heater configured to heat the dynamic tooling member such that, in operation, a solidified skin is formed on the material in less than five seconds, and wherein the stimulus solidifies the material at a rate of at least 0.1 millimeters/second through a thickness of the material.
45. The material shaping device of any one of the clauses herein, wherein the stimulus member is a first stimulus member spaced apart from the opening in a first direction, and wherein the material shaping device further comprises a second stimulus member spaced apart from the opening in a second direction opposite the first direction.
46. The material shaping device of any one of the clauses herein, wherein the stimulus member comprises a heated fluid, and wherein the dynamic tooling member further comprises a channel configured to receive the heated fluid.
47. The material shaping device of any one of the clauses herein, wherein the stimulus member comprises a light source configured to facilitate photoactivation of the portion of the material passing through the opening.
48. The material shaping device of any one of the clauses herein, wherein the dynamic tooling member has a long axis and a short axis normal to the long axis, the material shaping device further comprising a connector coupled and conforming to the dynamic tooling member along at least part of the long axis, wherein the actuator includes a roller slidably coupled to the dynamic tooling member via the connector.
49 A material shaping system, comprising:
   a material shaping device comprising:
      a dynamic tooling member positioned to receive a resin-coated material in an opening of the dynamic tooling member;
      actuators coupled to the dynamic tooling member and spaced apart from one another along a length of the dynamic tooling member, wherein individual actuators are configured to dynamically change a shape or position of the dynamic tooling member; and
      a stimulus member positioned to provide a stimulus to a portion of the resin-coated material passing through the opening of the dynamic tooling member, wherein the stimulus is configured to chemically alter the portion of the resin-coated material such that the resin-coated material becomes a desired structure; and
   a material moving assembly distal to at least part of the material shaping device, wherein the material moving assembly is configured to move the desired structure away from the material shaping device.
50. The material shaping system of any one of the clauses herein, further comprising:
   a feed assembly configured to output an input material; and
   a resin bath storing a resin, wherein the resin bath is positioned to receive the input material from the feed assembly and coat the input material in the resin to form the resin-coated material.
51. The material shaping system of any one of the clauses herein, wherein the feed assembly comprises a creel system.
52. The material shaping system of any one of the clauses herein, wherein the feed assembly is configured to output the input material in a plurality of material portions, and wherein the resin bath includes (i) a cavity storing the resin, (ii) a plurality of inlets coupled to the cavity and positioned to receive individual ones of the plurality of material portions, and (iii) an outlet coupled to the cavity and positioned to output the resin-coated material towards the dynamic tooling member.
53. The material shaping system of any one of the clauses herein, further comprising:
   a reservoir storing the resin-coated material;
   a flexible tubular member coupled to the reservoir and the dynamic tooling member; and
   a plunger operably coupled to the reservoir and configured to push the resin-coated material from the reservoir into the flexible tubular member such that the resin-coated material reaches the dynamic tooling member.
54 The material shaping system of any one of the clauses herein, wherein the dynamic tooling member comprises a nozzle that narrows in diameter in a direction distal to the flexible tubular member.
55. The material shaping system of any one of the clauses herein, wherein the material moving assembly comprises a gripper having a distal end portion configured to be coupled to the desired structure.
56. The material shaping system of any one of the clauses herein, wherein the material moving assembly comprises:
   a frame positioned downstream of the material shaping device;
   a first conveyor coupled to the frame; and
   a second conveyor movably coupled to the frame,
   wherein the second conveyor is movable to define a variable gap between the first and second conveyors, and
   wherein the first and second conveyors are configured to move the desired structure through the variable gap and away from the material shaping device.
57. A method of shaping a material, comprising:
   receiving a material in an opening of a dynamic tooling member;
   changing a shape of the dynamic tooling member such that the shape of the opening is imparted to the material passing through the opening; and
   applying a stimulus to a portion of the material passing the opening, wherein the stimulus chemically alters the portion of the material passing the opening such that the portion of the material retains the imparted shape.
58 The method of any one of the clauses herein, wherein applying the stimulus comprises applying at least one of heat, light, sound waves, or electromagnetic stimulation.
59 The method of any one of the clauses herein, further comprising immersing fibers in a resin, wherein the material comprises resin-coated fibers, and wherein applying the stimulus cures at least a portion of the resin of the resin-coated fibers.
60. The method of any one of the clauses herein, further comprising continuously moving the material through the gap or opening of the dynamic tooling member.

I/We claim:

1. A material shaping device, comprising:
a dynamic tooling member including an opening, wherein the dynamic tooling member is positioned to receive a material that, in operation, passes through the opening;
an actuator coupled to the dynamic tooling member, wherein the actuator is configured to dynamically change at least one of a shape, a position, a size, or an orientation of the opening of the dynamic tooling member, and wherein, in operation, the shape of the opening of the dynamic tooling member is imparted to a segment of the material passing through the opening; and
a stimulus member positioned to provide a stimulus to the material, wherein, in operation, the stimulus chemically alters at least a portion of the material such that the segment of the material passing through the opening retains the imparted shape.

2. The material shaping device of claim 1, wherein the dynamic tooling member includes a polymeric material.

3. The material shaping device of claim 1, wherein the dynamic tooling member includes a stimulus-transparent material.

4. The material shaping device of claim 1, wherein the dynamic tooling member comprises a first sheet and a second sheet spaced apart from the first sheet, wherein an inner surface of the first sheet and an inner surface of the second sheet together define at least part of the opening, wherein the actuator is a first actuator coupled to an outer surface of the first sheet, and wherein the material shaping device further comprises a second actuator coupled to an outer surface of the second sheet.

5. The material shaping device of claim 1, wherein the actuator is one of a plurality of actuators configured to dynamically change the shape of the opening of the dynamic tooling member.

6. The material shaping device of claim 5, wherein the actuators extend toward the dynamic tooling member in a plurality of directions, and wherein the actuators are coupled to a plurality of corresponding discrete points along the dynamic tooling member.

7. The material shaping device of claim 1, wherein the actuator comprises a motor configured to change the orientation of the opening of the dynamic tooling member.

8. The material shaping device of claim 1, wherein the stimulus member comprises a heater configured to heat the material.

9. The material shaping device of claim 1, wherein the material is configured to pass distally through the opening, wherein the stimulus is positioned (i) distal to the actuator and (ii) above or below the dynamic tooling member.

10. The material shaping device of claim 1, wherein the material comprises a resin, and wherein the stimulus member is positioned to cure the resin in less than 10 seconds to form a thermoplastic or thermoset polymeric material.

11. The material shaping device of claim 1, wherein the material comprises at least one of an epoxy-anhydride resin, an epoxy resin, a vinyl ether resin, a cyclic ether resin, a polyester resin, a cycloalkenyl resin, a dicyclopentadiene resin, an acrylic resin, a methacrylic resin, a methacrylamide resin, a vinyl ester resin, or a urethane resin.

12. The material shaping device of claim 1, wherein the material comprises fibers infused or coated with a resin.

13. The material shaping device of claim 1, wherein the stimulus member comprises a heater configured to (i) heat the dynamic tooling member such that, in operation, a solidified skin is formed on the material in less than five seconds, and (ii) solidify the material at a rate of at least 0.1 millimeters/second through a thickness of the material.

14. The material shaping device of claim 1, wherein the stimulus member is a first stimulus member spaced apart from the opening in a first direction, and wherein the material shaping device further comprises a second stimulus member spaced apart from the opening in a second direction opposite the first direction.

15. The material shaping device of claim 1, wherein the stimulus member comprises a light source configured to facilitate photoactivation of the portion of the material passing through the opening.

16. The material shaping device of claim 1, wherein the dynamic tooling member has a long axis and a short axis normal to the long axis, the material shaping device further comprising a connector coupled and conforming to the dynamic tooling member along at least part of the long axis, wherein the actuator includes a roller slidably coupled to the dynamic tooling member via the connector.

17. A material shaping system, comprising:
a material shaping device comprising:
a dynamic tooling member positioned to receive a resin-coated material in an opening of the dynamic tooling member;
actuators coupled to the dynamic tooling member and spaced apart from one another along a length of the dynamic tooling member, wherein individual actuators are configured to dynamically change at least one of a shape or a position of the opening of the dynamic tooling member; and
a stimulus member positioned to provide a stimulus to a portion of the resin-coated material, wherein the stimulus is configured to chemically alter the portion of the resin-coated material such that the resin-coated material adopts a desired geometry; and
a material moving assembly configured to move the resin-coated material through the opening of the dynamic tooling member.

18. The material shaping system of claim 17, further comprising:
a feed assembly configured to output an input material; and
a resin bath storing a resin, wherein the resin bath is positioned to receive the input material from the feed assembly and coat the input material in the resin to form the resin-coated material.

19. The material shaping system of claim 17, wherein the stimulus member is configured to (i) heat the portion of the resin-coated material or (ii) facilitate photoactivation of the portion of the resin-coated material.

20. The material shaping system of claim 17, wherein the material moving assembly comprises a gripper having a distal end portion configured to be coupled to the resin-coated material.
